(19) United States
(12) Patent Application Publication
(10) Pub. No.: US 2026/0064878 A1
(43) Pub. Date: Mar. 5, 2026

(54) TRACKING PERSONALLY IDENTIFIABLE INFORMATION ACROSS DISTRIBUTED SYSTEMS

(71) Applicant: Coupang Corp., Songpa-gu (KR)

(72) Inventors: Brett Anthony Matthes, Seoul (KR); Xunyu Yao, Shanghai (CN); Kiran Sama, Dublin, CA (US); Gurbhej Singh Dhindsa, Fremont, CA (US)

(21) Appl. No.: 18/823,187

(22) Filed: Sep. 3, 2024

(51) Int. Cl. G06F 21/62; H04L 9/40

(52) U.S. Cl. CPC G06F 21/6245; H04L 63/1408; H04L 63/1441

(57) ABSTRACT

The present disclosure relates to methods and systems for tracking personally identifiable information (PII) flow amongst distributed systems. The method includes receiving, at one or more computing devices, a data packet that includes a header and a payload. The data packet is detected by a sensor deployed within the distributed system. The sensor monitors data flow through an application programming interface (API). Based on information included in the header, a source and a destination associated with the data flow through the API are identified. A data breach is identified, if, in addition to other criteria being satisfied, at least one PII element is identified within the payload of the data packet. In response to determining that the data flow constitutes a data breach, a signal is generated which affects the data flow.

### TECHNICAL FIELD

The present disclosure relates to preventing data breaches in distributed systems.

### BACKGROUND

Use of personally identifiable information (PII) is often needed for providing customers with various types of service. For example, an e-commerce platform may need to obtain PII such as names, addresses, credit card numbers etc. to process transactions on the platform. However use of PII within a system can make the system a target of malicious activities such as data breaches.

### SUMMARY

In modern complex software systems, PII often flows through multiple systems or modules thus making comprehensive tracking of PII challenging. For example, in a system implemented in a containerized computing environment such as Kubernetes, various modules of the system may be spread over multiple nodes of the containerized system and/or communicate with multiple external/third-party systems. If such a system obtains/uses PII from users, the PII can flow among the modules of the system as well as to and from external systems in order to provide the intended services to the users. Because PII is often the target of malicious data breaches, proper management of PII is both extremely important and challenging. Fragmented and/or manual tracking/management of PII often results in insufficient data protection and poses challenges in regulatory compliance. The technology described herein provides an automated, integrated solution that can monitor and manage PII throughout its lifecycle—even in complex distributed systems—thus providing robust security and compliance to privacy regulations.

A method for mitigating unauthorized access to personally identifiable information (PII) in a containerized computing environment is presented. The method includes receiving, at one or more computing devices, a data packet that includes a header and a payload. The data packet is detected by a sensor deployed within the containerized computing environment. The sensor is configured to monitor data flow through an application programming interface (API) within the containerized computing environment. The one or more computing devices identify, based on information included in the header, a source and a destination associated with the data flow through the API. The one or more computing devices also identify at least one PII element within the payload of the data packet and determine that inclusion of the at least one PII element in the data flow between the source and the destination constitutes a breach. In response to determining that the inclusion of the at least one PII element in the data flow between the source and the destination constitutes the breach, the one or more computing devices generate a signal configured to affect the data flow between the source and the destination.

Detecting the data packet and monitoring the data flow include monitoring hypertext transfer protocol traffic from the source to the destination. The sensor may be configured to obtain metadata about the containerized computing environment and transmit the metadata to the one or more computing devices. The one or more computing devices determine that the data flow constitutes the breach based on the metadata. The one or more computing devices are configured to generate one or more signals configured to affect the data flow between the source and the destination, based on the metadata. Exemplary metadata includes at least one of a service name, a container image, a port of the containerized computing environment, a hostname header, and a trace ID. The sensory may identify a schema structure of the payload. The schema structure includes one or more schema structure elements and corresponding values for the one or more schema structure elements. The sensor generates a list of the schema structure elements, which excludes the corresponding values, and transmits the list of schema structure elements to the one or more computing devices. The one or more computing devices identify at least one PII element within the payload, based on a comparison of each element of the list of schema structure elements with a PII data dictionary. The signal may be configured to block a response to a request for data packets from the source or the destination, or to block a transmission of data packets to the source or the destination. Determining that including at least one PII element in the data flow constitutes the breach includes determining, over a first period of time, a baseline state of PII data flow through the API. Determining the breach also includes determining, over a second period of time after the first period of time, that a difference between (i) a portion of a second PII data flow through the API and (ii) a corresponding portion of the baseline state of PII data flow through the API satisfies a threshold condition associated with the breach. The threshold condition associated with the breach may include at least one of: a number of API calls, a number of PII elements, a number of services with respect to one or more IP addresses, or a frequency of inclusion of one or more PII elements in API calls.

A system is presented for mitigating unauthorized access to personally identifiable information (PII) in a containerized computing environment. The system includes memory storing computer-readable instructions and one or more computing devices operatively coupled to the memory and configured to execute the computer-readable instructions to perform operations. The operations include receiving a data packet that includes a header and a payload. The data packet is detected by a sensor deployed within the containerized computing environment. The sensor is configured to monitor data flow through an application programming interface (API) within the containerized computing environment. The operations include identifying, based on information included in the header, a source and a destination associated with the data flow through the API. The operations also include identifying at least one PII element within the payload of the data packet and determining that inclusion of the at least one PII element in the data flow between the source and the destination constitutes a breach. The operations include, in response to determining that the inclusion of the at least one PII element in the data flow between the source and the destination constitutes the breach, generating a signal configured to affect the data flow between the source and the destination.

A non-transitory computer readable medium is presented for storing instructions that, when executed by one or more computing devices, cause the one or more computing devices to execute operations to mitigate unauthorized access to personally identifiable information (PII) in a containerized computing environment. The operations include receiving a data packet that includes a header and a payload, the data packet being detected by a sensor deployed within the containerized computing environment, the sensor configured to monitor data flow through an application programming interface (API) within the containerized computing environment. The operations include identifying, based on information included in the header, a source and a destination associated with the data flow through the API and identifying at least one PII element within the payload of the data packet. The operations include determining that inclusion of the at least one PII element in the data flow between the source and the destination constitutes a breach. The operations include, in response to determining that the inclusion of the at least one PII element in the data flow between the source and the destination constitutes the breach, generating a signal configured to affect the data flow between the source and the destination.

Implementations of the above aspects can provide one or more of the following advantages. By providing for automated tracking of PII in complex distributed systems (e.g., a containerized system such as Kubernetes implemented using a Linux kernel), the flow of PII among various portions of the system, as well as to and from external systems, can be accurately monitored, and any anomalies can be quickly detected. This in turn can allow for effective visualization of the PII flows and/or quick detection of any potential breaches. Widespread malicious breaches may therefore be potentially preempted by taking timely and appropriate measures to obviate any anomalous or unexpected routing of PII within a system. Further, the technology described herein allows for tracking data flows to and from various application programming interfaces (APIs) within a containerized system via software agents or sensors that can be non-intrusively installed in a system on an ad-hoc or post-hoc basis. As such, the technology allows for arbitrary scalability and ad-hoc or post-hoc implementations within existing systems without requiring major redesigns or disruptions. Also, use of decentralized sensors/agents tracking information exchange between various pairs/sets of APIs allows for isolation/blocking of specific portions of a system potentially without affecting operations of the overall system.

Other features and advantages of the present disclosure will be apparent from the following detailed description, figures, and claims.

### BRIEF DESCRIPTION OF THE DRAWINGS

FIG. 1 is a diagram of an example system for tracking PII.

FIG. 2 depicts a schematic diagram of an example dataflow server within the system shown in FIG. 1.

FIG. 3 illustrates an example of a display of the data traffic.

FIG. 4 illustrates a flowchart of an example process for tracking PII in accordance with technology described herein.

FIG. 5 illustrates a flowchart of an example process for detecting anomalous flow of PII within a system.

FIG. 6 illustrates an example electronic device within a network and system.

### DETAILED DESCRIPTION

The present disclosure relates to a system and method for preventing unauthorized transmission of personally identifiable information (PII) in distributed systems.

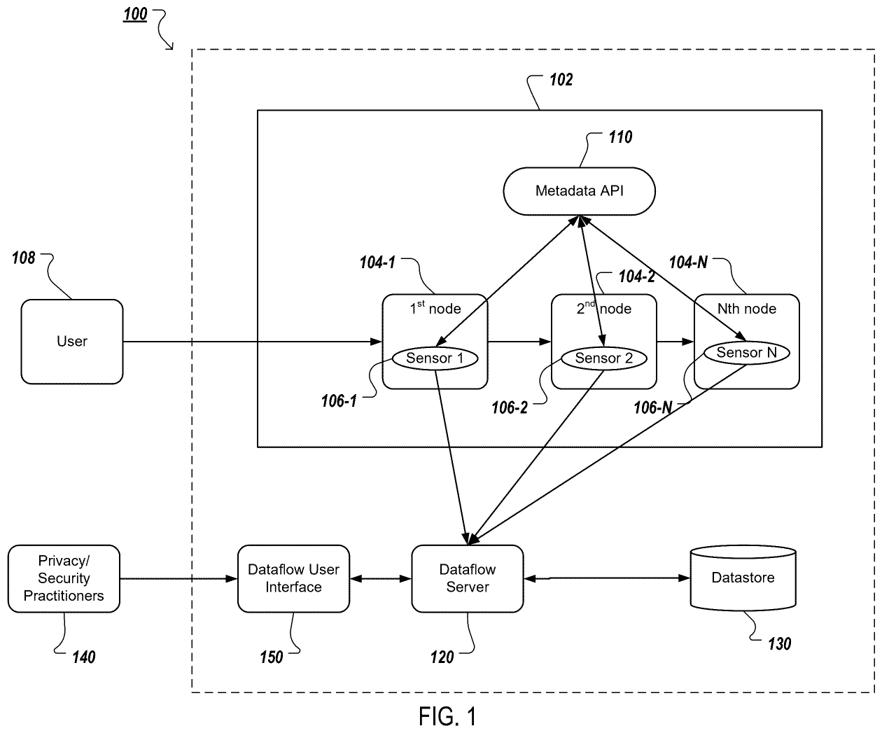

FIG. 1 illustrates an example of a system 100 for identifying and preventing unauthorized PII data flow. In some implementations, the system 100 operates within a containerized computing environment/compute platform 102. A containerized computing environment 102 can support a software deployment process in which a particular application or service is (or multiple applications or services are) packaged with relevant components such as libraries and dependencies, into a single unit called a container. Such containerization may, in some cases, facilitate simplified deployment, effective resource utilization, and application reliability in distributed computing environments. Within the containerized computing environment 102 there are multiple nodes 104, such as a 1^{st} node 104-1, a 2^{nd} node 104-2, . . . up to an Nth node 104-N. Each node can include one or more pods which can include one or more containers for an API or an agent for requesting, receiving, and transmitting data packets. In addition, a service can run on a node, for instance the same node as a pod or in a different node. For example, the first node 104-1 may include a shopping cart for a user 108. The second node 104-2 may include an orders API. The third node 104-N may include a payments API. A node 104 has an associated sensor such as a 1^{st} sensor 106-1, a 2^{nd} sensor 106-2, . . . up to an Nth sensor 106-N. The user 108 may interact with at least one of the nodes 104. For example, a user 108 may interact with a shopping cart running as a service in a first node 104-1. As a node 104, or a service within the node 104, requests and receives information, the sensors 106 track the information being requested, transmitted, and received by the various nodes 104. For example, if a node 104 has multiple services running, then the sensor 106 may provide a process ID for each of the services along with the information from the packets themselves: payload schema, origin, and destination information.

In some implementations, within the containerized computing environment 102 there is a metadata API 110 for tracking the nodes and also for tracking information/metadata about the containerized computing environment 102. In some implementations, a sensor 104 communicates with the metadata API 110 and/or a dataflow server 120 external to the containerized computing environment 102. The dataflow server 120 may store data on a datastore 130. A security practitioner 140 may interact with the dataflow server 120 by a dataflow user interface 150.

The sensor 106 may include a software agent. An example of a sensor 106 is an enhanced Berkeley Packet Filter (e-BPF) and an example of a containerized computing environment 102 is Kubernetes. The e-BFP may operate as part of the Kubernetes daemonset. The sensors 106 may monitor live hyper text transfer protocol (HTTP) traffic/data packets transmitted and received through the nodes 104 including those data packets transmitted or received from outside the containerized computing environment 102, such as to or from users 108. In addition to filtering the data packets, the sensors 106 may augment the request/response data from the nodes 104 with metadata from the containerized computing environment 102, which they receive from the metadata API 110.

As the various nodes 104 request data, transmit data, and receive data, the associated sensors 106 track the requests, transmissions, and receipts. The various nodes 104 send and receive data packets. The data packets include a header and a payload. The header comprises information regarding the routing of the data packet and my also comprise encoding information such as the method by which the information in the payload has been encrypted. The routing information may include a source of the data packet and a destination of the data packet. The payload information may be encrypted. As each node 104 receives a data packet, the sensor 106 may decrypt the payload, gather information about the payload schema, and transmit this information (e.g. payload schema, source, and destination) to a metadata API 110 and also to a dataflow server 120. The information the sensors 106 gather and transmit explicitly excludes any payload values. In some implementations, the sensors 106 remove the values from the payload and send only a schema structure element (or a list of schema structure elements) and the information from the header of the data packet (e.g., source and destination, encryption method) to the dataflow server 120. In this manner no PII is actually transmitted to the dataflow server 120. This aspect of the method provides additional security by neither transmitting PII data to the dataflow server 120 nor storing the PII data on the datastore 130. Such precautions prevent transmission to the dataflow server 120 and reduce chances of the datastore 130 becoming targets of malicious actors to steal PII.

Because the sensors 106 can be non-intrusively installed as software agents in a system after the system has already started operations, this technique can be implemented without building the system from scratch and with existing components. In addition, these techniques enable easily scaling to larger systems and enable ad-hoc or post-hoc implementations within existing systems without requiring major redesigns or disruptions.

In addition, the sensors 106 may also include any information received from the metadata API 110 in their transmission to the dataflow server 120. In some implementations, the sensors 106 may collect additional information by querying the metadata API 110 about details related to the particular node 104 being monitored or related to a particular data packet being monitored. In an example, the sensor 106 may request metadata from the metadata API 110 about services and modules related to the node 104 or to the data packet being transmitted. The metadata API 110 may also extract details about the containerized computing environment 102. In some implementations the metadata API 110 transmits the metadata directly to the dataflow server 120. In other implementations the metadata API 110 transmits the metadata only to the sensors 106, which may include the metadata in their own transmissions to the dataflow server 120. Examples of such containerized computing environment metadata include the names of services, names of modules, deployment variables, container images, ports available within the containerized computing environment, ports used or accessed by services or modules, names of other APIs running in the containerized computing environment 102, a host on which the pod is running, a hostname header, and a trace ID.

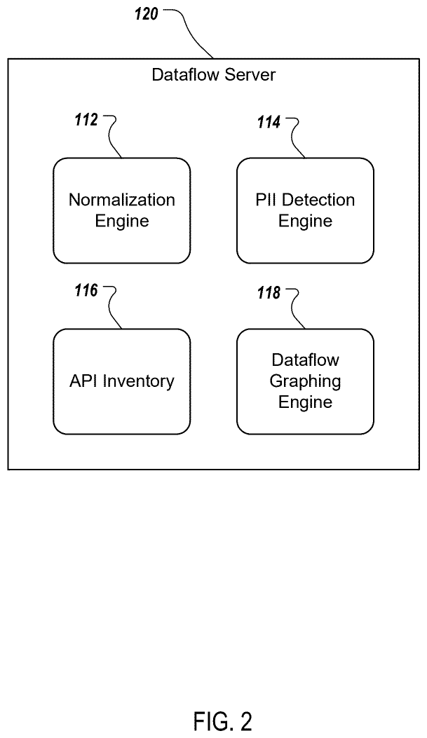

At the dataflow server 120, the information collected by the sensors 106 and by the metadata API 110 can be analyzed and stored in the datastore 130. FIG. 2 illustrates example components of the dataflow server 120. Specifically, in some implementations, the dataflow server 120 may include a normalization engine 112, a PII detection engine 114, an API inventory 116, and a dataflow graphing engine 118.

In an example, the normalization engine 112 may normalize uniform resource information (URI) received from the sensors 106 and from the metadata API 110. The normalization performed by the normalization engine 112 may precede storing the data in the datastore 130. In an example of normalization performed by the normalization engine 112, the routing information of a data packet may include HTTP URIs (uniform resource identifiers) and the data normalization engine 112 may replace the dynamic values from the HTTP URIs using, for example, regex to find and replace dynamic strings from the URI. In an example, the URI has dynamic parts. If the URI includes a portion “/users/user1”, “/users/user2”, “/users/user3”, “/users/userA” etc., a determination may be made that all of these represent the same API which can then be normalized to a common representation such as “/users/{param}”. The normalization engine 112 may count the number of child nodes (e.g., a number of how many different values of {param} are possible on a given/users) and may store the result in the datastore 130. Similarly, the data normalization engine 112 may perform normalization on the data collected by the sensors 106 about the data packets (e.g., source, destination, payload schema, etc.) and may also perform normalization on the metadata from the metadata API 110.

In an example of data normalization, service identifiers may include relevant information about the purpose of the identifier (e.g., ID1234_shopping_cart). In some implementations, the identifier may include a number of random or pseudo-random characters to make the identifier unique. In some implementations, a service may be identified using only a number or alpha-numeric string (e.g. abCDEF87654ZYXWvu2t3_service1234). In some implementations, normalization of the service identifiers, metadata, and other data includes removal of the portions that identify individual data entities to focus on portions that that represent the type of data. For example, random or pseudo-random portions assigned to identify individual data entities may be ignored or removed in understanding data flows within a system.

The dataflow server 120 may also track the sources and destinations of the data packets. For example, the dataflow server 120 may parse the header information sent by the sensors 106 to track a hostname header and trace identifier. Parsing this information enables the dataflow server 120 to detect which data packets may be transmitting PII, for example, to an unauthorized entity. This information may also enable discovery that a particular IP address is requesting PII without authorization or need to do so.

In some implementations, the PII detection engine 114 may include a PII dictionary of terms that are associated with personally identifiable information in the list of schema structure elements of data packet payloads. Some examples of PII schema terms are shown in Table 1. In some implementations, the payloads of the transmitted or received data packets are scanned by the sensors 106 and these payload schema structure elements—but not the values themselves—are transmitted to the dataflow server 120. At the dataflow server, the payload schema elements are compared with the list of terms in the PII dictionary by the PII detection engine 114. When a match is found then the node 106 associated with the data packet is labelled as one that is transmitting/receiving PII and the API inventory 116 is updated accordingly. In addition to matching payload schema structure elements with terms in the PII schema dictionary, the PII detection engine 114 may also identify new payload schema structure elements as terms for inclusion in an updated PII schema dictionary. Thus, over time, as more PII schema terms are included in the PII schema dictionary, the detection capabilities of the system 100 may improve.

TABLE 1
Example PII schema terms
#10 Sample key names

account_no
access_token
owner_name
passport
recipient_number
user_email
year_of_birth
home_address
credit_card
customer_mobile

The API inventory 116 comprises a list APIs or nodes 104 which have sensors tracking their information flow. The API inventory 116 may also include additional information associated with the nodes 104 and APIs including metadata about the containerized computing environment 102 collected by the metadata API 110. The API inventory 116 may include information about blacklisted APIs, nodes, or IP addresses. The API inventory 116 may include information about the containerized computing environment 102 such as a list of services and which APIs or nodes 104 each service interacts with as well as which ports the services have access to.

The API inventory 116 may include information about nodes 104 or APIs which have been transmitting or receiving data packets comprising PII elements in their schemas. An example API inventory is shown in Table 2:

TABLE 2
Example API Inventory

Service Name: Seller Backend
API: /seller/orders
Http Method: GET
Schema: [ { “order_id”:””, “customer_name”:”” } ]

Data packets sent or received from within and from outside the containerized computing environment 102 can be monitored as described above. As new nodes 104 are added with APIs, the new APIs are matched against the API inventory 116 and sensors 106 are deployed to track the data packets the new APIs send and receive.

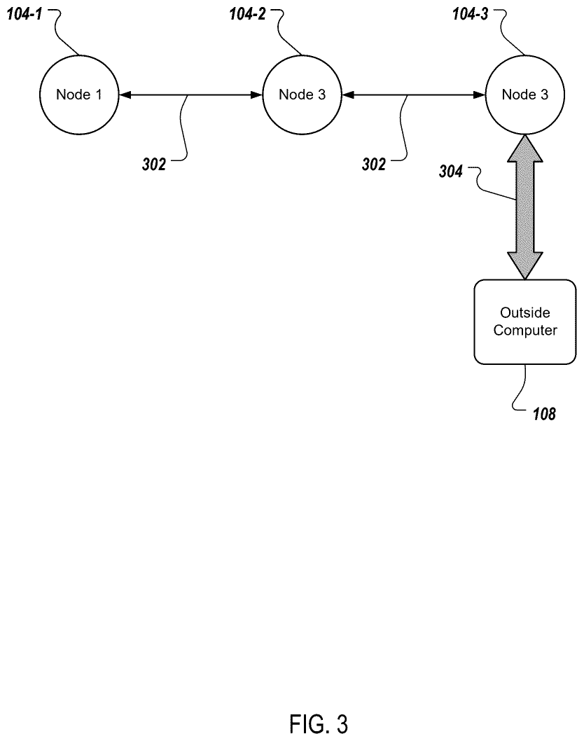

In some implementations, the dataflow server 120 also may include a dataflow graphing engine 118. The dataflow graphing engine 118 can display ongoing or historic traffic flow amongst the nodes 104 including to users 108. In some implementations, the dataflow graphing engine 118 receives the details of the transmission and/or receipt of PII. In some implementations, the dataflow graphing engine 118 accesses this information from the datastore 130 and/or the API inventory 116. In some implementations, the dataflow graphing engine 118 can be configured to generate, for output on a display device, a graphic illustrating the traffic flow of PII. FIG. 3 illustrates an example of such a graphic. In the example illustrated, the circles are nodes 104 with the PII traffic flows depicted as arrows 302, 304. The nodes 104-1, 104-2, and 104-3 receive and transmit PII at a low rate so the arrows 302 connecting the nodes 104-1, 104-2, and 104-3 are narrow. The third node 104-3 also transmits or receives data packets with PII at a high rate to an outside computer 108, so the arrow 304 corresponding to that data flow is wider than the low rate arrows 302. Upon detection of such a high rate of transmission of PII to an outside computer 108 the dataflow server can automatically throttle back or extinguish that particular transmission of PII. The dataflow graphing engine 118 may display such a graphic of PII traffic flow on the dataflow user interface 150.

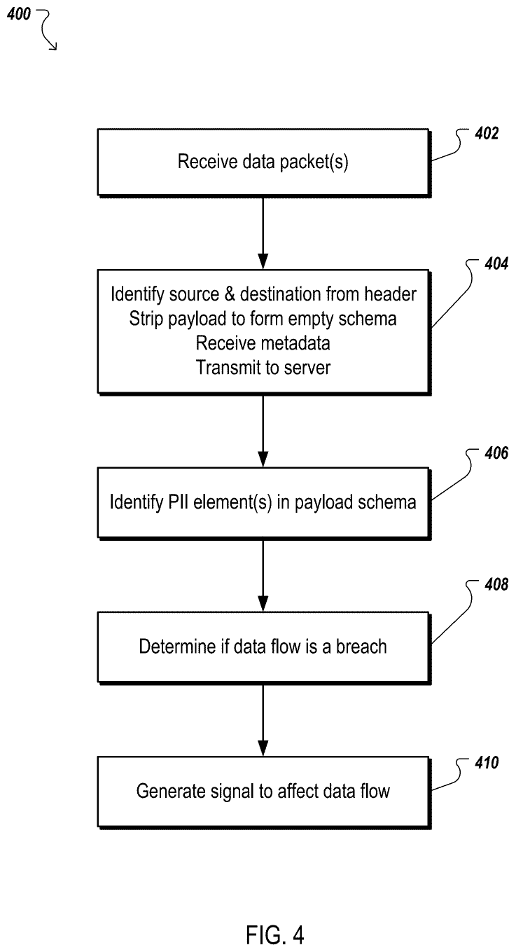

FIG. 4 illustrates a flowchart of an example process for tracking PII. At least a portion of this example process is performed by the dataflow server 120. The method 400 includes a step of receiving data packets 402 at a node 104 with a sensor 106. The data packets contain information in their header and in their payload.

At step 404, the sensors 106 associated with the node 104 process the information in the header of the data packets to identify a source and a destination of the data packet. The source and destination may include IP addresses, local addresses, other nodes 104 operating within the containerized computing environment 102, or other sources and destinations. The sensors 106 also decrypt the payload, temporarily store the payload, and remove all values from the stored payload to form an empty payload schema. The sensors 106 also receive optionally metadata about the containerized computing environment 102 from the metadata API 110. The sensors 106 transmit the source and the destination (from the header), the schema structure element (or list of schema structure elements) of the payload, and (optionally) any metadata to the dataflow server 120. In some implementations the sensors 106 do not transmit metadata to the dataflow server because the metadata API 110 sends the metadata to the dataflow server 120 directly. The sensors 106 perform this processing of the data packet payload only on a copy of the data packet and do not necessarily alter the actual data packet's payload at this stage of the process. The altering of a payload may be instituted by the dataflow server at step 410, below.

At step 406, the dataflow server 120, by using the PII detection engine 114, identifies any PII elements in the data packet. In an example, the schema structure of the data packet is compared with a PII dictionary. The PII dictionary contains terms related to PII. Some examples were provided in Table 1, above. If any of the schema terms match a term in the PII dictionary, then the data packet is identified as one which contains PII (or could contain PII). In some implementations, more complicated matching schemes can be used. For example, if the schema includes more than a threshold number of PII terms from the PII dictionary, then the data packet is considered to be transmitting PII. In another example, a similarity calculation may be performed between, for example, the PII dictionary and the schema structure and only similarities exceeding a certain threshold are considered to be transmitting PII. In another example, if a particular IP address starts sending requests for a large number of PII data (e.g., a threshold multiple of the average number of PII fields from other IP addresses determined during the baseline measurements), then the particular IP address may be flagged as an anomaly and the traffic to and/or from the particular IP address blocked or routed for additional analysis, for example.

At step 408, the dataflow server 120 identifies whether any PII (or other) data flow constitutes a data breach. In an example, a security practitioner 140 may have stored a list of IP addresses authorized to have access to PII in the datastore 130. If any of the sources or destinations of the data packets are not on this authorized list, any data packets being transmitted to or from those destinations can be identified as a data breach. In another example, the security practitioner 140 may have identified a list of authorized APIs which are stored in the API inventory 116. In an example, if the authorized APIs are only authorized to receive and transmit PII during certain times of the day, and an authorized API attempts to receive or transmit PII outside of that time window, then the dataflow server may identify such transmission as a data breach.

At step 410, in response to having identified a data flow as a data breach, the dataflow server 120 may generate a signal to affect the data packet transmission. In an example, the dataflow graphing engine 118 may present a display of the transmission of data packets amongst the nodes 104 and may sound an alarm or change a color of one of the displayed data transmissions. In another example, the dataflow server 120 may send an alert including details about the data breach. In another example, the dataflow server 120 can prevent transmission of additional PII-containing data packets to a particular destination, from a particular source, or to or from a particular user 108. In another example, after the dataflow server 120 has identified a data breach associated with a particular node 104, the dataflow server 120 may send only data packets with incorrect information to that node 104 or may trace the data packets which are sent to the particular node 104. In another example, certain nodes 104 may have authorization to transmit PII only at certain times of the day. If such a node 104 attempted to transmit or receive PII outside of this permitted time window, the node could be prevented from transmitting data packets containing PII during the impermissible time window. In another example, once the dataflow server 120 has identified a data breach, it can send an IP address associated with the data breach to an edge firewall which will block future requests to or from that IP address. In another example, the data packets associated with the breach can be recorded and analyzed to learn more about the data breach such as whether there are any commonalities from the PII being leaked. The dataflow server 120 may also isolate an identified “bad” node without affecting the other nodes and without affecting data traffic generally throughout the system.

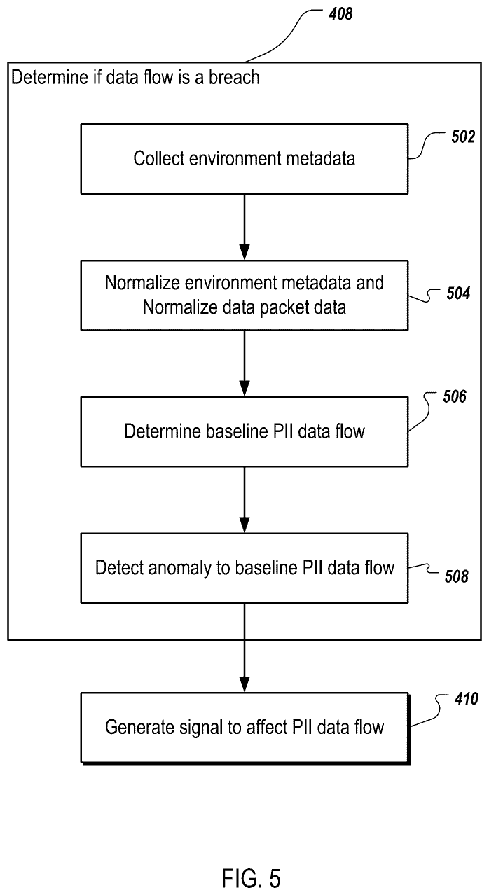

FIG. 5 illustrates a flowchart of an example process for detecting anomalous flow of PII within a system. The determination of a data breach 408 may include anomaly detection. To determine whether a data flow is anomalous two steps must be undertaken: (1) data and metadata are collected over a first time period to establish a baseline and (2) additional data and metadata are collected over a second time period and compared with the baseline. Thus, the data and metadata may be collected as in steps 402-406 above for a certain period of time. In addition, if metadata was not already collected during step 404, then metadata about the data flow and the containerized computing environment 102 may be collected at step 502, over the same period of time during which the data was collected.

The data and the metadata are also normalized, stored, and analyzed at step 504. The normalization step can be substantially similar to as described above with reference to FIG. 1.

At step 506, a baseline PII data flow for the first period of time is established. Establishing a baseline may include recording PII data flows to and from certain nodes 104 over specific time sub-periods. For example, the baseline PII data flow may be different during local business hours than at other times of day. The period of time over which the baseline may be determined may range from a short time (e.g. tens of seconds, a few minutes) to longer periods of time (e.g. one week, a month, an entire year, or even several years). For example, users of a particular service may be most active during the early evening hours of weekdays and equally active all daylight hours on the weekends, but very inactive at night. Collecting data and metadata for several weeks and analyzing the collected data and metadata would be sufficient to establish a baseline by reveal such pattern. An example anomaly from the above situation would occur if a particular one of the nodes 104 requests PII at an unusual time of day (e.g., 2 am) when the baseline indicates that is the least active time for requesting PII. Another example anomaly may occur when a particular node 104 starts to request much more PII than is usual for any individual user 108. In another example, requiring longer data and metadata collection times to establish a baseline, in the weeks leading up to a holiday the data flow patterns may change significantly. Establishing such a baseline prior to an annual holiday, may require collecting data over many months. In another example, requiring shorter collection times to establish a baseline, one day's worth of collection may be sufficient to establish that users only request or transmit PII during business hours and that the traffic peaks during mid-day. In such an example, any request for PII outside of business hours would be considered an anomaly and likely a data breach.

Thus establishing the baseline PII data flow may include identifying different times of day and also which particular nodes 104 are more or less likely to have more of less PII data flow. The baseline may include noting the number of PII-containing data packets which are exchanged between particular nodes 104 during each hour of the business day on weekdays and noting the different number of PII-containing data packets exchanged between particular nodes 104 during non-business hours and on weekends. In another example, establishing the baseline may mean noting that two particular nodes exchange large numbers of PII-containing data packets at particular times of the day, such as 5-6 pm or 00:00 hours to 01:00 hours. Other techniques for identifying patterns in the data flow may also be used. In an example, determining a baseline flow of PII-containing data packets may include establishing a threshold condition, which, if exceeded, constitutes a data breach. Example thresholds include a number of API calls, a number of PII elements, a number of services with respect to one or more IP addresses, and a frequency of inclusion of one or more PII elements in API calls, but threshold conditions are not limited to these examples.

At step 508, an anomaly relative to the baseline PII data flow is detected. Detecting anomalies at this step can include comparing the established baseline from step 506 with the current, or historical, PII data flow. In some implementations, the dataflow server 120 measures the number of data packets containing PII which are exchanged between two nodes over the previous 60 minutes. If that number exceeds the threshold number of PII containing data packets measured during the establishment of the baseline, then this instance may be labelled as an anomaly. In another example, the number of PII containing data packets may vary from the baseline by a set amount, e.g., by +/−10% of the baseline value. In another example, if a particular node requests and receives PII containing data packets outside of business hours, this action can be labelled as an anomaly relative to the baseline that has established that such requests and receipts outside of business hours as atypical. In an example, if the frequency of inclusion of one or more PII elements in API calls exceeds a threshold frequency, then the situation can be identified as an anomaly. In another example, the threshold may include a number of API calls, a number of PII elements requested or transmitted, or a number of services with respect to one or more IP addresses, and the like.

Some anomaly detection methods involve establishing a baseline and then developing a complex model (e.g., a machine learning model, a neural network model, etc.) to learn what would be considered as “appropriate” data traffic in a given context. Other methods involve use of logic rules that may be less resource intensive and/or have faster response times than some machine-learning based complex models. In an example, a logic rule may dictate flagging a data flow as potentially suspicious if PII-containing data packets over the data flow exceed a threshold number within a particular time period.

At step 410, the dataflow server 120 may generate a signal to alter the traffic flow. If no anomaly is detected, then the system may merely continue to monitor PII data flow without additional reaction or may continue to show normal data flow on the dataflow user interface 150. If an anomaly is detected, then the dataflow server 120 may react in several ways. For example, the dataflow server 120 may send a signal to the node 104 to stop sending the data packet containing PII to a destination, if, for example, the destination is on a blacklist of “do not send” destinations in the API inventory 116 or in the datastore 130. Other examples of actions taken the dataflow server 120 are described in reference to FIG. 2 and FIG. 4.

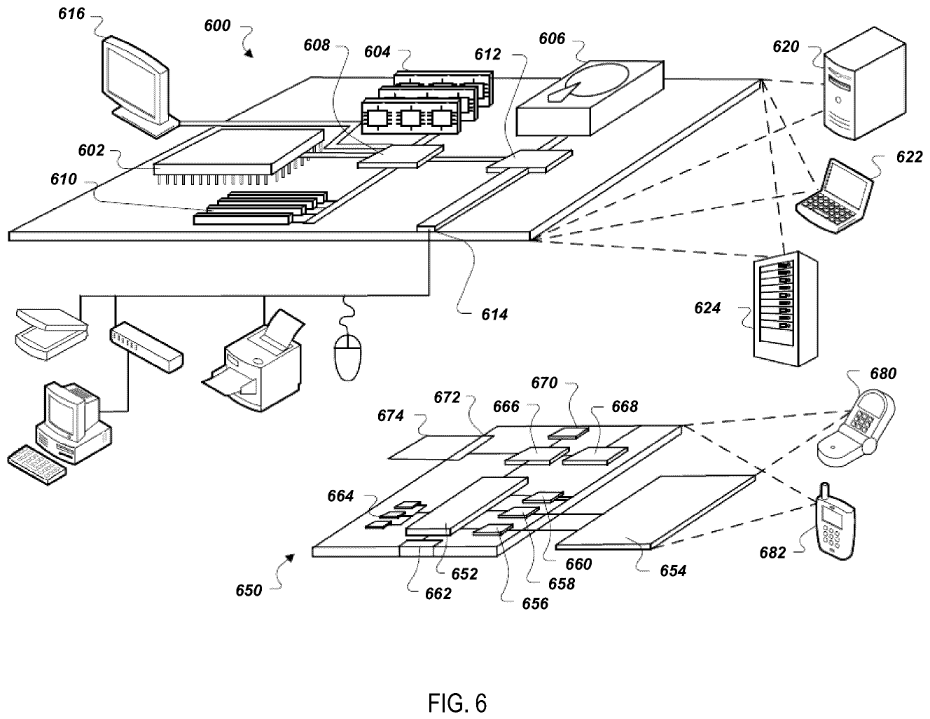

FIG. 6 shows an example of a computing device 600 and a mobile computing device 650 (also referred to herein as a wireless device) that are employed to execute implementations of the present disclosure. The computing device 600 is intended to represent various forms of digital computers, such as laptops, desktops, workstations, personal digital assistants, servers, blade servers, mainframes, and other appropriate computers, for instance such as the system 100 described with reference to FIG. 1. The mobile computing device 650 is intended to represent various forms of mobile devices, such as personal digital assistants, cellular telephones, smart-phones, AR devices, and other similar computing devices, for instance how a user 108 may access the system 100. The components shown here, their connections and relationships, and their functions, are meant to be examples only, and are not meant to be limiting. The computing device 600 and/or the mobile computing device 650 can form at least a portion of the PII traffic tracking system 100 described above, such as the containerized computing environment 102, the dataflow server 120, and the datastore 130 as described above with reference to FIG. 1 and FIG. 2.

The computing device 600 includes a processor 602, a memory 604, a storage device 606, a high-speed interface 608, and a low-speed interface 612. In some implementations, the high-speed interface 608 connects to the memory 604 and multiple high-speed expansion ports 610. In some implementations, the low-speed interface 612 connects to a low-speed expansion port 614 and the storage device 606. Each of the processor 602, the memory 604, the storage device 606, the high-speed interface 608, the high-speed expansion ports 610, and the low-speed interface 612, are interconnected using various buses, and may be mounted on a common motherboard or in other manners as appropriate. The processor 602 can process instructions for execution within the computing device 600, including instructions stored in the memory 604 and/or on the storage device 606 to display graphical information for a graphical user interface (GUI) on an external input/output device, such as a display 616 coupled to the high-speed interface 608. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 604 stores information within the computing device 600. In some implementations, the memory 604 is a volatile memory unit or units. In some implementations, the memory 604 is a non-volatile memory unit or units. The memory 604 may also be another form of a computer-readable medium, such as a magnetic or optical disk.

The storage device 606 is capable of providing mass storage for the computing device 600. In some implementations, the storage device 606 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 602, perform one or more methods, such as those described above. The instructions can also be stored by one or more storage devices, such as computer-readable or machine-readable media, such as the memory 604, the storage device 606, or memory on the processor 602.

The high-speed interface 608 manages bandwidth-intensive operations for the computing device 600, while the low-speed interface 612 manages lower bandwidth-intensive operations. Such allocation of functions is an example only. In some implementations, the high-speed interface 608 is coupled to the memory 604, the display 616 (e.g., through a graphics processor or accelerator), and to the high-speed expansion ports 610, which may accept various expansion cards. In some implementations, the low-speed interface 612 is coupled to the storage device 606 and the low-speed expansion port 614. The low-speed expansion port 614, which may include various communication ports (e.g., Universal Serial Bus (USB), Bluetooth, Ethernet, wireless Ethernet) which may be coupled to one or more input/output devices. Such input/output devices may include a scanner, a printing device, a keyboard, or a mouse. The input/output devices may also be coupled to the low-speed expansion port 614 through a network adapter. Such network input/output devices may include, for example, a switch, or a router.

The computing device 600 may be implemented in a number of different forms, as shown in the FIG. 6. For example, it may be implemented as a standard server 620, or multiple times in a group of such servers. In addition, it may be implemented in a personal computer such as a laptop computer 622. It may also be implemented as part of a rack server system 624. Alternatively, components from the computing device 600 may be combined with other components in a mobile device, such as a mobile computing device 650. Each of such devices may contain one or more of the computing devices 600 and the mobile computing device 650, and an entire system may be made up of multiple computing devices communicating with each other. The computing device 600 may be implemented in the user/external computer 108, the dataflow server 120, datastore 130, and the containerized computing environment 102 described with respect to FIGS. 1-2.

The mobile computing device 650 includes a processor 652; a memory 664; an input/output device, such as a display 654; a communication interface 666; and a transceiver 668; among other components. The mobile computing device 650 may also be provided with a storage device, such as a micro-drive or other device, to provide additional storage. Each of the processor 652, the memory 664, the display 654, the communication interface 666, and the transceiver 668, are interconnected using various buses, and several of the components may be mounted on a common motherboard or in other manners as appropriate. In some implementations, the mobile computing device 650 may include a camera device(s) (not shown).

The processor 652 can execute instructions within the mobile computing device 650, including instructions stored in the memory 664. The processor 652 may be implemented as a chipset of chips that include separate and multiple analog and digital processors. For example, the processor 652 may be a Complex Instruction Set Computers (CISC) processor, a Reduced Instruction Set Computer (RISC) processor, or a Minimal Instruction Set Computer (MISC) processor. The processor 652 may provide, for example, for coordination of the other components of the mobile computing device 650, such as control of user interfaces (UIs), applications run by the mobile computing device 650, and/or wireless communication by the mobile computing device 650.

The processor 652 may communicate with a user through a control interface 658 and a display interface 656 coupled to the display 654. The display 654 may be, for example, a Thin-Film-Transistor Liquid Crystal Display (TFT) display, an Organic Light Emitting Diode (OLED) display, or other appropriate display technology. The display interface 656 may include appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a Single in Line Memory Module (SIMM) card interface. The expansion memory 674 may provide extra storage space for the mobile computing device 650, or may also store applications or other information for the mobile computing device 650. Specifically, the expansion memory 674 may include instructions to carry out or supplement the processes described above, and may include secure information also. Thus, for example, the expansion memory 674 may be provided as a security module for the mobile computing device 650, and may be programmed with instructions that permit secure use of the mobile computing device 650. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 652, perform one or more methods, such as those described above. The instructions can also be stored by one or more storage devices, such as one or more computer-readable or machine-readable mediums, such as the memory 664, the expansion memory 674, or memory on the processor 652. In some implementations, the instructions can be received from a propagated signal, such as, over the transceiver 668 or the external interface 662.

The mobile computing device 650 may communicate wirelessly through the communication interface 666, which may include digital signal processing circuitry where necessary. The communication interface 666 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS). Such communication may occur, for example, through the transceiver 668 using a radio frequency. In addition, short-range communication, such as using a Bluetooth or Wi-Fi, may occur. In addition, a Global Positioning System (GPS) receiver module 670 may provide additional navigation-related and location-related wireless data to the mobile computing device 650, which may be used as appropriate by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, etc.) and may also include sound generated by applications operating on the mobile computing device 650.

The mobile computing device 650 may be implemented in a number of different forms, as shown in FIG. 6. Other implementations may include a phone device 680 and a tablet device 682. The mobile computing device 650 may also be implemented as a component of a smart-phone, personal digital assistant, AR device, or other similar mobile device.

Computing device 600 and/or 650 can also include USB flash drives. The USB flash drives may store operating systems and other applications. The USB flash drives can include input/output components, such as a wireless transmitter or USB connector that may be inserted into a USB port of another computing device.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any disclosure or of what may be claimed, but rather as descriptions of features that may be specific to particular examples of particular disclosures. Certain features that are described in this specification in the context of separate examples can also be implemented in combination in a single example. Conversely, various features that are described in the context of a single example can also be implemented in multiple examples separately or in any suitable subcombination. Moreover, although features may be described herein as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the examples described herein should not be understood as requiring such separation in all examples, and it should be understood that the described program components and systems can generally be integrated together in a single product or packaged into multiple products.

Particular examples of the subject matter have been described. Other examples are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method for mitigating unauthorized access to personally identifiable information (PII) in a containerized computing environment, the method comprising:
receiving, at one or more computing devices, a data packet that includes a header and a payload, the data packet being detected by a sensor deployed within the containerized computing environment, the sensor configured to monitor data flow through an application programming interface (API) within the containerized computing environment;
identifying, by the one or more computing devices based on information included in the header, a source and a destination associated with the data flow through the API;
identifying at least one PII element within the payload of the data packet;
determining, by the one or more computing devices, that inclusion of the at least one PII element in the data flow between the source and the destination constitutes a breach; and
in response to determining that the inclusion of the at least one PII element in the data flow between the source and the destination constitutes the breach, generating, by the one or more computing devices, a signal configured to affect the data flow between the source and the destination.

2. The method of claim 1, wherein detecting the data packet and monitoring the data flow comprise monitoring hypertext transfer protocol traffic from the source to the destination.

3. The method of claim 1, wherein the sensor is further configured to:
obtain metadata about the containerized computing environment; and
transmit the metadata to the one or more computing devices.

4. The method of claim 3, wherein the one or more computing devices are configured to determine, based on the metadata, that the data flow constitutes the breach.

5. The method of claim 3, wherein the one or more computing devices are configured to generate, based on the metadata, one or more signals configured to affect the data flow between the source and the destination.

6. The method of claim 3, wherein the metadata comprises at least one of a service name, a container image, a port of the containerized computing environment, a hostname header, and a trace ID.

7. The method of claim 1, wherein identifying the at least one PII element within the payload comprises:
identifying, by the sensor, a schema structure of the payload, the schema structure including one or more schema structure elements and corresponding values for the one or more schema structure elements;
generating, by the sensor, a list of the schema structure elements, wherein the list excludes corresponding values; and
transmitting, by the sensor, the list of schema structure elements to the one or more computing devices.

8. The method of claim 7, further comprising: identifying, by the one or more computing devices, based on a comparison of each element of the list of schema structure elements with a PII data dictionary, the at least one PII element within the payload.

9. The method of claim 1, wherein the signal configured to affect the data flow between the source and the destination is configured to block a response to a request for data packets from the source or the destination, or to block a transmission of data packets to the source or the destination.

10. The method of claim 1, wherein determining that inclusion of the at least one PII element in the data flow constitutes the breach comprises:
determining, over a first period of time, a baseline state of PII data flow through the API; and
determining, over a second period of time after the first period of time, that a difference between (i) a portion of a second PII data flow through the API and (ii) a corresponding portion of the baseline state of PII data flow through the API satisfies a threshold condition associated with the breach.

11. The method of claim 10, wherein the threshold condition associated with the breach includes at least one of: a number of API calls, a number of PII elements, a number of services with respect to one or more IP addresses, or a frequency of inclusion of one or more PII elements in API calls.

12. A system for mitigating unauthorized access to personally identifiable information (PII) in a containerized computing environment, the system comprising:
memory storing computer-readable instructions; and
one or more computing devices operatively coupled to the memory, the one or more computing devices configured to execute the computer-readable instructions to perform operations comprising:
receiving a data packet that includes a header and a payload, the data packet being detected by a sensor deployed within the containerized computing environment, the sensor configured to monitor data flow through an application programming interface (API) within the containerized computing environment;
identifying, based on information included in the header, a source and a destination associated with the data flow through the API;
identifying at least one PII element within the payload of the data packet;
determining that inclusion of the at least one PII element in the data flow between the source and the destination constitutes a breach; and
in response to determining that the inclusion of the at least one PII element in the data flow between the source and the destination constitutes the breach, generating a signal configured to affect the data flow between the source and the destination.

13. The system of claim 12, wherein detecting the data packet and monitoring the data flow comprise monitoring hypertext transfer protocol traffic from the source to the destination.

14. The system of claim 12, wherein the operations further comprise:
receiving metadata about the containerized computing environment;
determining, based on the metadata, that the data flow constitutes the breach; and
generating, based on the metadata, one or more signals configured to affect the data flow between the source and the destination.

15. The system of claim 14, wherein the sensor is further configured to:
obtain the metadata; and
transmit the metadata to the one or more computing devices.

16. The system of claim 12, wherein identifying at least one PII element within the payload of the data packet comprises:
identifying a schema structure of the payload, the schema structure including one or more schema structure elements and corresponding values for the one or more schema structure elements; and
generating a list of the schema structure elements, wherein the list excludes corresponding values.

17. The system of claim 16, wherein the operations further comprise:
receiving the list of schema structure elements; and
comparing each element of the list of schema structure elements with a PII data dictionary to identify at least one PII element within the payload.

18. The system of claim 12, wherein the signal is configured to block a response to a request for data packets from the source or the destination, or to block a transmission of data packets to the source or the destination.

19. The system of claim 12, wherein the operations further comprise:
determining, over a first period of time, a baseline state of PII data flow through the API; and
determining, over a second period of time after the first period of time, that a difference between (i) a portion of a second PII data flow through the API and (ii) a corresponding portion of the baseline state of PII data flow through the API satisfies a threshold condition associated with the breach.

20. A non-transitory computer readable medium storing instructions that, when executed by one or more computing devices, cause the one or more computing devices to execute operations to mitigate unauthorized access to personally identifiable information (PII) in a containerized computing environment, the operations comprising:
receiving a data packet that includes a header and a payload, the data packet being detected by a sensor deployed within the containerized computing environment, the sensor configured to monitor data flow through an application programming interface (API) within the containerized computing environment;
identifying, based on information included in the header, a source and a destination associated with the data flow through the API;
identifying at least one PII element within the payload of the data packet;
determining that inclusion of the at least one PII element in the data flow between the source and the destination constitutes a breach; and
in response to determining that the inclusion of the at least one PII element in the data flow between the source and the destination constitutes the breach, generating a signal configured to affect the data flow between the source and the destination.
